(19) United States
(12) Patent Application Publication
(10) Pub. No.: US 2026/0039533 A1
(43) Pub. Date: Feb. 5, 2026

(54) Phase-Modulation Converter and Method for Calibrating the Phase-Modulation Converter

(71) Applicant: Siemens Aktiengesellschaft, Muenchen (DE)

(72) Inventors: Robert WEIKERT, Burggriesbach (DE); Dirk PROCHASKA, Chemnitz (DE); Alexander HELMDACH, Chemnitz (DE); Oliver RAAB, Ortenburg (DE)

(21) Appl. No.: 19/287,017

(22) Filed: Jul. 31, 2025

(30) Foreign Application Priority Data
Aug. 1, 2024 (EP) 24192351

(51) Int. Cl. H04L 27/36; H04B 17/11

(52) U.S. Cl. CPC H04L 27/36; H04B 17/11

(57) ABSTRACT

A method for calibrating a phase-modulation converter that includes an amplitude modulator with carrier suppression, an adder, a limiter and a demodulation facility to which a signal output by the limiter is suppliable and demodulated therein, wherein a comparison of the signal output by the limiter with a reference signal occurs in the context of the demodulation, a calibration switch, which is connected upstream of the adder which is actuatable between a control setting in which the adder, is connected via the calibration switch to the input of the phase-modulation converter, and at least one calibration setting in which the is interrupted, where in a calibration setting of the calibration switch, the phase position of the reference signal is changed, preferably dynamically, and a phase position of the reference signal is found at which an output signal of the demodulation facility assumes a calibrated value.

### BACKGROUND OF THE INVENTION

### 1. Field of the Invention

The invention relates to a method for calibrating a phase-modulation converter and phase-modulation converter.

### 2. Description of the Related Art

An analog-to-digital converter serves to convert an analog input variable into a digital signal. Conventional analog-to-digital converters are, for example, the successive approximation register (SAR) converter and the sigma-delta converter. Both converter types have disadvantages associated with them, resulting from DC voltage errors in the analog input signal.

EP 3 624 334 A1 discloses a further-developed apparatus for converting an analog input signal into a digital output signal. Specifically, it concerns an analog-to-digital converter (ADC) which is based upon the difference in the phase position of a signal that is modulated to the input signal to be measured as compared with a reference signal. The conventional analog-to-digital converter disclosed in EP 3 624 334 A1 can also be designated a phase-modulation converter.

The phase-modulation converter disclosed in EP 3 624 334 A1 comprises an amplitude modulator with carrier suppression for providing a carrier-free amplitude modulated signal. The amplitude modulator has a signal input at which an analog input signal that is to be converted can be fed in. Furthermore, an adder is provided to which the carrier-free amplitude-modulated signal output by the amplitude modulator is supplied and which is configured to add to this a carrier signal displaced by 90° and to provide a phase-modulated signal. Furthermore, a limiter is provided to which the phase-modulated signal output by the adder is supplied and which is configured to suppress an interference-induced amplitude modulation in the phase-modulated signal.

The resulting output signal of the limiter has an amplitude that consists of 0 or 1. It could also be said that the amplitude has a digital signal. The length of these pulses is continuous-valued dependent upon the selected carrier frequency. The information is contained in the length of the square-wave pulses. The output signal of the limiter carries the modulation in temporally differing zero crossings as compared with the 90° carrier signal. Here, reference is made to the figures in EP 3 624 334 A1, in particular to FIGS. 5 to 8 therein, alongside the associated description that describes the principle in greater detail.

The signal output by the limiter, which is denoted herein for short as a limited signal, can subsequently be sampled, where the sampling should occur sufficiently rapidly to acquire the zero crossings (sampling theorem).

For analog-to-digital converters, it has proved to be useful, in particular, before they are put into operation, to perform a calibration. This is, for instance, to compensate for PCB time delay differences. The abbreviation PCB stands therein for printed circuit board.

In conventional analog-to-digital converters, as mentioned in the introduction, a calibration of the offset often occurs at the manufacturing plant. Herein, the input voltage is set, for example, to 0V and the associated digital value is stored for later computational corrections. The applicants are also aware that a calibration can also occurs during operation. For this purpose, either a short-term wiring change is needed on the system of the user or corresponding circuit elements are provided in the analog circuit. In technical terms, this can conventionally be solved via SSR relays or transistors that are controlled by a logic system already present on the electrically isolated side. This type of calibration must, however, always be connected to the sensor from which the signal comes that is to be converted without influencing the system. A short-circuit of an active sensor by the measuring electronics should be avoided. This leads to further circuit complexity.

The applicants are also aware that with conventional analog-to-digital converters, bidirectional analog inputs are implemented (+/−10V, +−20 mA). In contrast to unidirectional inputs, however, significantly more circuit complexity is required herein, because the first amplification stages in the signal conditioning must be able to measure a negative input voltage. Therefore, it is often necessary to provide a positive and a negative supply voltage for these amplification stages. Associated therewith, for example, are additional windings in the transformers, the switching regulator, additional linear regulators and additional passive components for filtration. As an alternative to the build-up of the negative supply voltage, as far as the applicants are aware, there are concepts in which the input voltage is applied at half the reference voltage. Subsequently, the signal is read in as a fully or pseudo-differential signal to a conventional ADC. In this solution, additional exact resistances are needed in the operational amplifier circuit. Furthermore, the common mode rejection of the operational amplifier is negatively influenced by a mismatch of the resistances.

These problems have no significance for the principle of the phase-modulation converter, because herein the input voltage is converted into a correspondingly modulated voltage. However, it has proved to be the case that due, inter alia, to time delays on the PCB, i.e., the printed circuit board, on which the phase-modulation converter and/or components thereof are realized, including the analog filter stages, sometimes it is not possible to define exactly one zero point.

### SUMMARY OF THE INVENTION

In view of the foregoing, it is an object of the present invention to provide a method via which a calibration of a phase-modulation converter can be performed. Furthermore, it is an object of the invention to provide a phase-modulation converter with which such a method can be performed.

These and other objects and advantages are achieved in accordance with the invention by a method for calibrating a phase-modulation converter, where the phase-modulation converter comprises an amplitude modulator with carrier suppression to which an input signal to be converted can be supplied on the input side in order to obtain a carrier-free amplitude-modulated signal, an adder to add a phase-displaced, preferably sinusoidal, adder carrier signal to the carrier-free amplitude-modulated signal and to obtain a phase-modulated signal, a limiter to which the phase-modulated signal can be supplied and with which an interference-induced amplitude modulation in the phase-modulated signal can be suppressed, and a demodulation facility to which the signal output by the limiter can be supplied and therein can be demodulated, where in the context of the demodulation, a comparison of the signal output by the limiter with a reference signal can occur, and where the adder carrier signal can be generated in the demodulation facility.

In addition, a calibration switch which is connected upstream of the adder, in particular, between the amplitude modulator and the adder, and which can be actuated between a control setting in which the adder is connected via the calibration switch to an input of the phase-modulation converter, and at least one calibration setting in which the connection between the adder and the input of the phase-modulation converter is interrupted and preferably another connection is created, in particular, a connection of the adder to earth or ground, where included in the method is a step S1 in a calibration setting of the calibration switch, in particular, when a connection to earth or ground is made, the phase position of the reference signal is changed, preferably dynamically, and a phase position of the reference signal is found at which an output signal of the demodulation facility assumes a calibrated value that represents the maximum value achievable at this phase displacement or differs by not more than a pre-determined maximum deviation from the maximum value achievable at this phase displacement.

The objects and advantages are also achieved in accordance with the invention by a phase-modulation converter, comprising an amplitude modulator with carrier suppression to which an input signal to be converted can be fed on the input side in order to obtain a carrier-free amplitude-modulated signal, an adder to add a phase-displaced, preferably sinusoidal, adder carrier signal to the carrier-free amplitude-modulated signal and to obtain a phase-modulated signal, a limiter to which the phase-modulated signal can be supplied and with which an interference-induced amplitude modulation in the phase-modulated signal can be suppressed, and a demodulation facility to which the signal output by the limiter can be fed and therein can be demodulated, where in the context of the demodulation, a comparison of the signal output by the limiter with a reference signal can occur, and where the adder carrier signal can be generated in the demodulation facility.

The phase-modulation converter additionally comprises a calibration switch that is connected upstream of the adder, in particular, between the amplitude modulator and the adder and which can be actuated between a control setting in which the adder is connected via the calibration switch to an input of the phase-modulation converter, and at least one calibration setting in which the connection between the adder and the input of the phase-modulation converter is interrupted and preferably another connection is created, in particular, a connection of the adder to earth or ground, where the phase-modulation converter is configured in order, for a calibration, to change the phase position of the reference signal, preferably dynamically, and to find a phase position of the reference signal at which an output signal of the demodulation facility assumes a calibrated value that represents the maximum value achievable at this phase displacement or differs by not more than a pre-determined maximum deviation from the maximum value achievable at this phase displacement.

In other words, an object of the invention is also to provide a phase-modulation converter that is configured for carrying out the method in accordance with the invention. The phase-modulation converter in accordance with the invention is configured to perform step S1 of the method, as disclosed herein.

In other words, the present invention particularly provides a dynamic offset calibration for a phase-modulation converter. It has proved to be the case that with a phase-modulation converter, a calibration via targeted active adaptation of the phase position of the reference signal that is used for the demodulation is possible. Thus, a signal can be used that is generated for the operation of the phase-modulation converter and is, in any case, available. In the manner in accordance with the invention, a reliable calibration of an analog-to-digital converter configured as a phase-modulation converter can occurs with a reasonable effort and, inter alia, it is possible to compensate for production and construction tolerances.

The phase-modulation converter in accordance with the invention via which the method can be performed is distinguished therein by having a relatively simple configuration.

The fact that the phase position of the reference signal is changed dynamically means, in particular, that a change occurs multiple times and repeatedly. The change suitably occurs until a desired value is achieved. This is preferably performed such that a maximum is reached and/or approached. For example, a first change can occur in one direction and it can be observed and/or established whether the starting value of the demodulator increases. If this is the case, then it is possible to proceed further in this direction, but otherwise, a change to the other direction occurs. This can be realized, for example, via at least one logical system.

If a calibration occurs to a value that differs by a pre-determined maximum deviation from the maximum value achievable at this phase displacement, then in a preferred embodiment, it is the case that the maximum deviation is 3%, in particular, 2%, preferably 1% of the maximum value achievable at this phase displacement.

By way of the calibration switch provided for this purpose, a short circuit can be created across the voltage on the demodulator side, in particular, the logic side. The input voltage can be set to zero in the adder in order subsequently to perform the calibration.

In order to set the input voltage to 0V, specifically solid state relays (SSRs) or simple Micro-Electromechanical Systems (MEMS) switches are suitable because thereby the advantage of the phase-modulation converter of a possible purely passive circuit on the processor side can again be used. The calibration switch can be configured, in particular, as a changeover switch. It can comprise at least one mechanical relay and/or at least one solid-state relay and/or at least one reed relay and/or at least one MEMS switch or can be provided thereby.

The calibration switch is connected upstream of the adder. It is situated before the adder in the input direction of the phase-modulation converter. The calibration switch can be situated, in principle, at any desired site on the signal path of the phase-modulation converter before the adder. In other words, it is situated between the input of the phase-modulation converter and the adder. It can be, but does not have to be the last component before the adder. One or more further components can be situated between the adder and the calibration switch, for example, at least one filter and/or at least one galvanic separation.

The calibration switch can be situated before or after the amplitude modulator, i.e., between the input of the phase-modulation converter and the amplitude modulator or between the amplitude modulator and the adder. The second embodiment thereof has proved to be particularly advantageous.

The calibration switch is configured to interrupt the signal path, which can be a differential signal path, and to create another connection. In the control setting, the calibration switch creates or provides a connection of the adder to the input of the phase-modulation converter—possibly via further components. It is preferably the case that, in the calibration setting, the calibration switch opens, i.e., interrupts the connection of at least one input of the adder which, in the control setting, is made (either directly or via one or more further components) to at least one output of the amplitude modulator. In the calibration setting, the calibration switch connects, in particular, at least one input of the adder situated in the signal path to earth and/or ground, where it should be understood this connection can also occur via further components, for instance, a connection of at least one input of the adder to earth/ground via the amplitude modulator and/or at least one filter and/or at least one galvanic separation or suchlike.

In the event that the adder has two inputs for a differential signal transfer, it is suitably the case that in the calibration setting the calibration switch connects each of the two inputs available for the differential signal transfer (rather than to the input of the phase-modulation converter and/or to the amplitude modulator) to earth and/or ground. More preferably, it can be the case in the event of differential signal transference that in the control setting of the calibration switch, both signal inputs of the adder are connected (either directly or also via one or more further components) to one of two differential outputs of the amplitude modulator.

The calibration of the phase-modulation converter can occur entirely without influencing the system to an external signal as a new zero phase position. This can advantageously be used if external analog signals have to be monitored, for example, for a relatively large change or a threshold value.

The property of the phase-modulation converter that the input voltage is mapped via an arctan function onto an output voltage can also be still better utilized. Small changes in the phase difference about the zero position result in a greater signal swing as compared with the same change at the edge of the input voltage region. This means that the signal-to-noise ratio remains constant for all the input voltages to a first approximation, which is not the case in conventional analog-to-digital converters.

The calibration in accordance with the invention of the phase-modulation converter can occur, for example, at least once before the first operation by the user, for instance, ex works. Alternatively or additionally, it is also possible that the calibration in accordance with the invention is performed at least once after the first operation, for instance, if the phase-modulation converter is installed in the field of an industrial plant and/or machine and is used, for example, for converting a sensor signal.

It has proved to be quite particularly suitable if the phase-modulation converter comprises at least one galvanic separation, which is suitably connected upstream of the calibration switch. Connected upstream therein means that it is arranged before the calibration switch in the input direction of the phase-modulation converter. In particular, at least one galvanic separation can be provided between the amplitude modulator and the adder. A galvanic separation preferably comprises at least one pair of coupling capacitors. This applies, in particular, in the case of a differential signal transfer and, in this case, a coupling capacitor for each of the two differential signal paths.

Depending upon the construction, it is then possible particularly easily, in particular, without the necessity for galvanically-isolated switching elements, to create a short-circuit across the amplitude-modulated voltage coming from the amplitude modulator, in particular, the switching modulator directly via coupling capacitor(s) on the logic side.

It is suitably the case that, in particular, starting at the output of the amplitude modulator and/or as far as the output of the limiter and/or the input of the demodulation facility, a differential signal transfer occurs. The phase-modulation converter in accordance with the invention is accordingly configured in a further embodiment. It can also be said that then at least starting from the output of the amplitude modulator and, in particular, at least as far as the output of the limiter and/or as far as the demodulation facility, a differential signal transfer is built up.

The adder can comprise at least one operational amplifier or can be provided thereby. This can be, in particular, at least one fully differential operational amplifier.

Preferably, an area overlap between the limited signal and the reference signal is calculated via the demodulation facility, in particular, over a plurality of periods. The demodulation facility can be constructed and/or configured accordingly.

The output signal of the demodulation facility the behavior of which is analyzed as the phase position of the reference signal, is varied in the calibration setting of the calibration switch is, in particular, the digital value(s) that the phase-modulation converter outputs.

In an advantageous embodiment, the phase-modulation converter and/or its demodulation facility comprises at least one field programmable gate array (FPGA) and/or at least one application-specific integrated circuit (ASIC). It can then be the case, in particular, that in the FPGA and/or in the FPGA evaluation and/or in the ASIC and/or the ASIC evaluation, the possibility is created or exists for displacing the phase position of the reference signal, preferably dynamically.

The phase-modulation converter in accordance with disclosed embodiments of the invention can have at least one logic system that is configured to change the phase position of the reference signal, preferably dynamically, and to find the phase position of the reference signal at which the output signal of the demodulation facility assumes the calibrated value that represents the maximum value achievable at this phase displacement or differs by not more than a pre-determined maximum deviation from the maximum value achievable at this phase displacement. A logic system of this type, which herein is designated a reference logic, can be a constituent part of the demodulation facility, for instance, provided and/or implemented on an FPGA thereof.

The actuation of the calibration switch into the desired setting can also be realized or become realized via a logic system.

It has also proved to be advantageous if the reference signal is generated from the output signal of an, in particular, voltage-controlled oscillator that forms a constituent part of a phase-locked loop and the dynamic change in the phase position of the reference signal is achieved because the phase position of a feedback signal for the oscillator that is tapped off on the output side of the oscillator and is supplied to the oscillator again, in particular, on the input side, is dynamically changed, in particular, by steps of less than 40°, preferably by steps of less than 20°, particularly preferably by steps of less than 10°.

It can be the case that the oscillator has at least one phase-variable tap and suitably at least one phase-locked tap, where the at least one phase-variable tap enables the 360° phase position of the oscillator to be subdivided into n steps, where n is a natural number greater than or equal to 30, in particular greater than or equal to 40, preferably greater than or equal to 50, particularly preferably greater than or equal to 100. It can then further be the case that the reference signal is obtained from the at least one phase-variable tap. The phase-variable tap can then output the reference signal and/or the reference signal can be tapped and/or drawn therefrom. The phase position of the reference signal can then be changed via corresponding control and/or setting of the phase-variable tap, in particular, dynamically, and by steps of 360°/n, until the desired value is obtained.

It is also possible that the phase-variable tap is connected to the feedback path of the oscillator so that a signal originating from the phase-variable tap can be supplied back again to the oscillator as a feedback signal, in particular, on the input side and the phase position of the signal originating from the phase-variable tap is changed by steps of 360°/n.

It can also be said that a phase-variable tap can either be used for the feedback path of the oscillator or directly, in effect in the “forward branch” in order to realize the phase position change of the reference signal.

The phase-modulation converter in accordance with disclosed embodiments of the invention, in particular, its demodulation facility, can have a reference signal generating module for generating the reference signal, which has proved to be a suitable design implementation. The reference signal generating module can then comprise the, in particular, voltage-controlled oscillator that forms a constituent part of a phase-locked loop and the reference signal can be generated from the output signal of the oscillator of the reference signal generating module. The oscillator can have at least one phase-variable tap and at least one phase-locked tap, where the at least one phase-variable tap enables the 360° phase position of the oscillator to be subdivided into n steps. The at least one phase-variable tap can be configured accordingly.

The reference signal can be obtainable directly from the phase-variable tap. However, the phase-variable tap can also be connected to the feedback path of the oscillator so that a signal originating from the phase-variable tap can be supplied back again to the oscillator as a feedback signal, in particular, on the input side and the phase-modulation converter, for example, a reference logic system thereof, is, in particular, configured to change the phase position of the signal originating from the phase-variable tap of the oscillator of the reference signal generating module, preferably dynamically, by steps of 360°/n.

In other words, a realization of the phase change can be achieved, for example, because an oscillator with a phase-variable tap that enables a subdivision of the phase position into fine steps is used. Purely by way of example, reference is made here to FPGAs by the manufacturer Xilinx and/or AMD that exist in a version with a mixed-mode clock-manager (MMCM) module that offers such a fine subdivision of the phase at a phase-variable tap. The corresponding function is designated “finePS”, which stands for “fine phase shift”. This option can be used in the context of the presently disclosed embodiments of invention to achieve an, in particular, dynamic, stepped change of the phase position, in particular, until a maximum is found. This is used, in particular, because the phase-variable tap is utilized for the and/or as the feedback signal for the oscillator. The applicants are aware, for example, of FPGA models from Xilinx and/or AMD which enable a subdivision of the phase (“finePS”) into 56 steps at a corresponding phase-variable tap, i.e., into steps of 360°/n, where n=56, which has proved to be suitable in the context of the disclosed embodiments of the invention. However, it should be emphasized that a finer or coarser subdivision is also possible and can be used. Further, by way of example, FPGAs from Lattice Semiconductor are known, in particular, the series EPS, ECP5, EPC5-5G which also enable a fine subdivision of the phase, specifically by up to 300 steps.

In accordance with another particularly preferred embodiment of the invention, a carrier signal generated via the demodulation facility is supplied to the amplitude modulator for the carrier suppression, the modulator carrier signal, in particular, at a further input of the amplitude modulator that can also be designated a carrier input, and that in a step S2, in the calibration setting of the calibration switch, in particular, when a connection to earth or ground is made, the phase position of the modulator carrier signal and/or of the adder carrier signal is changed, preferably dynamically, and therein a phase position of the modulator carrier signal and/or of the adder carrier signal is found at which an output signal of the demodulation facility assumes a calibrated value that represents the maximum value achievable at this phase displacement, i.e., the phase displacement of the modulator carrier signal and/or of the adder carrier signal, or differs by not more than a pre-determined maximum deviation from the maximum value achievable at this phase displacement.

If a calibration occurs to a value that differs by a pre-determined maximum deviation from the maximum value achievable at this phase displacement, in a preferred embodiment, then it is the case that the maximum deviation is 3%, in particular, 2%, preferably 1% of the maximum value achievable at this phase displacement.

In other words, in a step S2, apart from the pure calibration via the displacement of the reference signal, a further additional calibration can occur in order to ensure the positional relationship between the adder carrier signal and the modulator carrier signal. These two carrier signals are ideally distinguished by a phase displacement of 90° relative to one another. For example, the adder carrier signal can be sinusoidal and the modulator carrier signal can be cosinusoidal with a 90° phase offset. In step S2, the phase offset between the modulator carrier signal and the adder carrier signal is actively varied, preferably such that the maximum obtainable with this type of variation is obtained. The maximum results when the modulator carrier signal and the adder carrier signal are offset by 90° to one another. A deviation from the 90° results in a different-sized phase shift into the different directions, which can lead to inexact and/or erroneous results. By way of the calibration via the phase position of the modulator carrier signal and the adder carrier signal, inter alia, production and construction tolerances can be compensated for.

The step S2 is suitably performed at and/or with the phase position of the reference signal that was previously found in step S1.

It should be noted that in step S2, with a displacement of the phase position of the modulator carrier signal and/or the adder carrier signal, typically a higher value can be found as the maximum value than the maximum value in step S1. However, this is not necessarily the case. The value would not become still larger, for example, if at the start point of step S2 (randomly) a phase offset of exactly 90° were to exist between the modulator carrier signal and/or the adder carrier signal.

It is also self-evident that, in order to obtain a desired phase position of the modulator carrier signal and the adder carrier signal, it is sufficient if either (just) the phase position of the modulator carrier signal or (just) the phase position of the adder carrier signal is changed and the resultant output signal is observed, in particular, in order to obtain the maximum or a value sufficiently close to the maximum.

In an advantageous embodiment, the phase-modulation converter in accordance with disclosed embodiments of the invention is constructed and/or configured in order to perform step S2.

It can accordingly be provided in the phase modulator in accordance with disclosed embodiments of the invention that the amplitude modulator is connected to the demodulation facility and that a carrier signal generated via the demodulation facility can be supplied to the amplitude modulator for the carrier suppression, the modulator carrier signal, in particular, at a further input of the amplitude modulator, the carrier input, and that the phase-modulation converter has a logic system that is constructed and/or configured to change the phase position of the modulator carrier signal and/or of the adder carrier signal, preferably dynamically, and to find a phase position of the modulator carrier signal and/or of the adder carrier signal at which an output signal of the demodulation facility assumes a calibrated value that represents the maximum value achievable at this phase displacement or that differs by not more than a pre-determined maximum deviation from the maximum value achievable at this phase displacement, the adder logic system. In a preferred embodiment, the adder logic system forms a constituent part of the demodulation facility.

The modulator carrier signal and/or the adder carrier signal can also be generated from the output signal of an, in particular, voltage-controlled oscillator that forms a constituent part of the phase-locked loop.

The dynamic change in the phase position of the modulator carrier signal and/or of the adder carrier signal can then be achieved, for example, because the phase position of a feedback signal for the oscillator, that is tapped off on the output side of the oscillator and is supplied to the oscillator again, in particular, on the input side, is preferably dynamically changed, in particular, by steps of less than 40°, preferably by steps of less than 20°, particularly preferably by steps of less than 10°.

It is suitably the case that for the generation of the reference signal, an oscillator is used and for the generation of the modulator carrier signal and/or the adder carrier signal, at least one further oscillator is used. The at least two oscillators that can be used, firstly, for the reference signal and, secondly, for the modulator carrier signal and/or for the adder carrier signal can therein be, in principle, identically constructed. It has proved to be particularly suitable if, in order to generate the modulator carrier signal and the adder carrier signal, a common oscillator is used.

An oscillator used for the modulator carrier signal and/or for the adder carrier signal can also have at least one phase-variable tap and, optionally, at least one phase-locked tap, where the at least one phase-variable tap enables the 360° phase position of the oscillator to be subdivided into n steps, where n is a natural number greater than or equal to 30, in particular, greater than or equal to 40, preferably greater than or equal to 50, particularly preferably greater than or equal to 100.

It can then further be the case that the modulator carrier signal and/or the adder carrier signal is obtained from the at least one phase-variable tap. The phase-variable tap can then output the modulator carrier signal and/or the adder carrier signal and/or the modulator carrier signal and/or the adder carrier signal can be tapped and/or drawn therefrom. The phase position of the reference signal can then be changed via corresponding control and/or setting of the phase-variable tap, in particular, dynamically, and by steps of 360°/n, until the desired value is obtained.

It can also be provided, in relation to obtaining the modulator carrier signal and/or the adder carrier signal, that the phase-variable tap is connected to the feedback path of the oscillator so that a signal originating from the phase-variable tap can be supplied back again to the oscillator as a feedback signal, in particular, on the input side, and the phase position of the signal originating from the phase-variable tap is dynamically changed by steps of 360°/n. The at least one phase-variable tap can be configured accordingly.

In a further embodiment, the phase-modulation converter in accordance with the invention, in particular, its demodulation facility, can have a carrier signal generating module for generating the modulator carrier signal and/or the adder carrier signal. The carrier signal generating module can then comprise an, in particular, voltage-controlled oscillator that is a constituent part of a phase-locked loop, where the modulator carrier signal and/or the adder carrier signal can be generated from the output signal of the oscillator.

It can also be the case herein that the oscillator has at least one phase-variable tap and preferably at least one phase-locked tap, where the at least one phase-variable tap enables the 360° phase position of the oscillator to be subdivided into n steps, where n is a natural number greater than or equal to 30, in particular, greater than or equal to 40, preferably greater than or equal to 50, particularly preferably, greater than or equal to 100.

The modulator carrier signal and/or the adder carrier signal can be obtainable, for example, directly from the phase-variable tap. The carrier signal generating module is then configured accordingly.

Alternatively, the phase-variable tap can be connected to the feedback path of the oscillator so that a signal originating from the phase-variable tap can be supplied back again to the oscillator as a feedback signal, in particular, on the input side.

The phase-modulation converter, for example, an adder logic system thereof, can then be configured in both cases to change the phase position of the signal originating from the phase-variable tap of the oscillator of the carrier signal generating module, preferably dynamically, by steps of 360°/n. The at least one phase-variable tap can be configured accordingly.

In a particularly advantageous embodiment of the method in accordance with the invention, in a step S3 in the control setting of the calibration switch, the phase position of the reference signal is changed again, preferably dynamically, and therein a phase position of the reference signal is found at which an output signal of the demodulation facility assumes a calibrated value that is either zero or differs by not more than a pre-determined maximum deviation from zero or that represents half of the maximum value achievable at this phase displacement or that differs by not more than a pre-determined maximum deviation from half of the maximum value achievable at this phase displacement.

In an advantageous embodiment, the phase-modulation converter in accordance with the invention is constructed and/or configured in order to perform step S3.

Step S3 is suitably performed at and/or with the phase position of the modulator carrier signal and/or the adder carrier signal that was previously found in step S2.

Bidirectional industrial analog input channels can also be realized with little circuit complexity. As soon as there are requirements for a potential separation of the analog channels from the evaluating logic system, the solution can also be realized via a phase-modulation converter in accordance with disclosed embodiments of the invention that is also readily able to be calibrated during operation, significantly more easily than was previously achieved.

Particularly preferably, for step S3, if the calibration switch is in the control setting, then an input voltage of 0V is applied to the phase-modulation converter. In other words, step S3 can be performed, in particular, if and/or while an input voltage of 0V is applied to the phase-modulation converter. In other words, via this step, a calibration to 0V can be performed dependent upon the measurement range.

Optionally, in step S4, a “direction test” can also be performed. In particular, it can be provided that in step S4, if the calibration switch is in the control setting, then an input voltage other than zero is applied to the phase-modulation converter and a check is performed to determine whether the output signal of the demodulation facility in the event of an input voltage of over zero assumes a value that is greater than the value of the output signal at 0V input voltage and, in the event of an input voltage of below zero, assumes a value that is smaller than the value at an input voltage of 0V. If this is not the case, then the phase position of the reference signal is suitably displaced by 180°. It is also possible that the phase position of the reference signal is changed, preferably dynamically, in one direction until the value of the output signal of the demodulation facility at which it started comes about again. This change of the phase position of the reference signal is suitably performed if an input voltage of 0V is applied to the phase-modulation converter. The change can occur until the renewed finding of the output value, in particular, if no sufficiently exact setting of the 180° phase difference can be realized.

In the case of a phase-modulation converter, for an input voltage there can be two phase angles that lead to the same digital value. The reference signal with which the comparison is made can be arranged before or after the limited signal that is fed to the demodulation facility. Depending on the sequence of the reference signal and the limited signal, a different behavior results as to whether, with increasing input voltage, the digital value correspondingly increases or decreases. The sequence of reference signals and limited signal defines the sign of the gradient of the digital value. With the calibration according to step S4, in practice, a gradient with the right sign can then be achieved.

In an advantageous embodiment, the phase-modulation converter in accordance with disclosed embodiments of the invention is configured to perform step S4.

It has proved to be particularly advantageous if, in the context of the method according to the invention, steps S1, S2 and S3 (and optionally S4) are performed in this sequence and/or if the phase-modulation converter in accordance with disclosed embodiments of the invention is configured to perform steps S1, S2 and S3 (and optionally S4) in this sequence. Then, a particularly reliable, comprehensive calibration of the phase-modulation converter can be achieved.

A reference signal generating module and/or a carrier signal generating module can be components of a clock generating facility of the phase-modulation converter, preferably a clock generating facility of the demodulation facility of the latter.

In particular, making use of at least one logic system, an automated calibration can be performed in the context of which step S1, optionally step S2 and also optionally step S3 and S4 occur. More than one logic system can also be provided and/or a common logic system can comprise more than one module for the steps. As noted above, for example, a reference logic system and an adder logic system can be utilized to realize the phase position changes.

The amplitude modulator with carrier suppression can be, for example, a (digital) switch modulator, such as a double push-pull modulator or a (digital) ring modulator. The switch modulator preferably comprises at least one, in particular, digital switch and/or at least one mechanical relay and/or at least one reed relay and/or at least one MEMS switch or is provided thereby.

The phase-modulation converter in accordance with disclosed embodiments of the invention can form a constituent part of an, in particular, memory-programmable control system, in particular, an input and/or an input assembly thereof. It is also possible that the phase-modulation converter in accordance with disclosed embodiments of the invention forms a constituent part of a measuring apparatus, for instance, an oscilloscope or, in particular, a digital multimeter, where it is herein the case that it is then a constituent part of an input and/or an input assembly.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages of the present invention will now be described in detail by reference to the accompanying drawings, in which:

FIG. 1 shows a purely schematic representation of an exemplary embodiment of a phase-modulation converter in accordance with the invention;

FIG. 2 shows a clock generator facility, XOR module, integrator and further components of an alternatively configured demodulation facility for the use of four sampling clock signals in an enlarged, purely schematic representation;

FIG. 3 shows a clock generator facility, XOR module, integrator and further components of the demodulation facility of the phase-modulation converter of FIG. 1 in an enlarged, purely schematic representation;

FIG. 4 shows the three clock generator blocks of the clock generator facility of the phase-modulation converter of FIG. 1 in an enlarged representation;

FIG. 5 shows a schematic representation of the sequence of Sig_{RF} and Sig_{BA} for the case of a unidirectional or bidirectional measurement;

FIG. 6 shows three vector diagrams relating to the modulator carrier signal Sig_{MT}, the adder carrier signal Sig_{AT} offset therefrom, the reference signal Sig_{RF}, the amplitude-modulated signal Sig_{AM} and the phase-modulated signal Sig_{PM};

FIG. 7 shows six further vector diagrams relating to the modulator carrier signal Sig_{MT}, the adder carrier signal Sig_{AT} offset therefrom, the reference signal Sig_{RF}, the amplitude-modulated signal Sig_{AM} and the phase-modulated signal Sig_{PM}; and

FIG. 8 is a flowchart of the method in accordance with the invention.

### DETAILED DESCRIPTION OF THE EXEMPLARY EMBODIMENTS

In the figures, similar elements and components have the same reference signs.

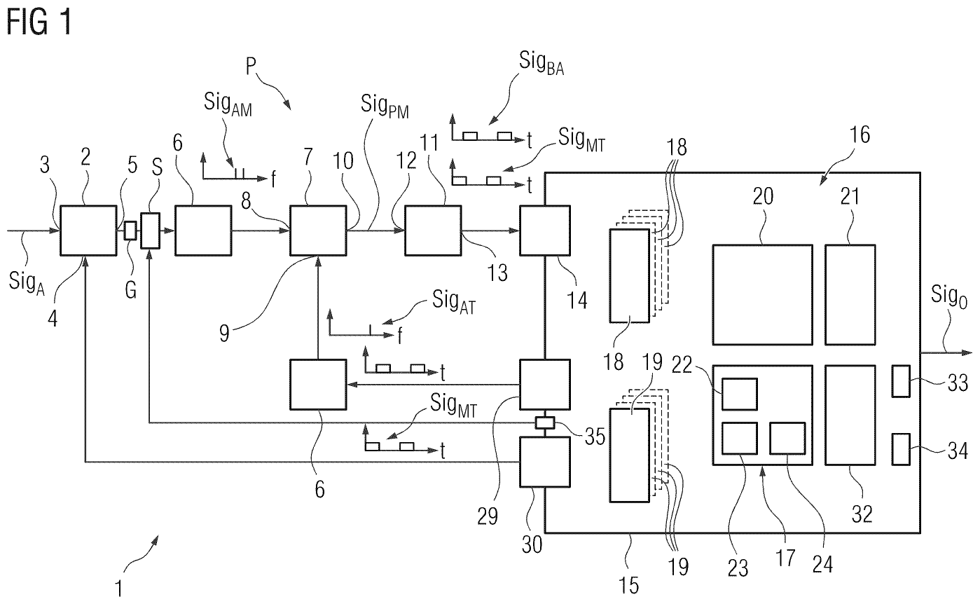

FIG. 1 shows, in a purely schematic block diagram, an exemplary embodiment of a phase-modulation converter 1 in accordance with the invention for converting an analog input signal Sig_{A} into a digital output signal Sig_{O}.

The phase-modulation converter 1 comprises an amplitude modulator 2 with carrier suppression to which an analog signal Sig_{A} that is to be converted can be and/or is supplied at an input 3. The amplitude modulator 2 is configured to receive from the analog input signal Sig_{A} a carrier-free amplitude-modulated signal Sig_{AM} which is transferred via two differential lines to the subsequent stages. It should be noted that in the figures, the lines and inputs for the differential transfer are not both shown separately, but rather, for the sake of clarity, just one is shown. The amplitude modulator 2 can be, for example, a switch modulator or a ring modulator. A switch modulator can comprise at least one, in particular, digital switch and/or at least one mechanical relay and/or at least one reed relay and/or at least one MEMS switch, or can be provided thereby.

At a further input 4 which, in order to distinguish it from the input 3, can also be designated the carrier input 4, a square-wave or sinusoidal modulator carrier signal Sig_{MT}, the creation of which is described in greater detail below, is supplied to the amplitude modulator 2. From the output 5 of the amplitude modulator 2, an amplitude-modulated signal Sig_{AM} emerges as a differential signal.

The amplitude-modulated signal Sig_{AM} subsequently passes through an analog filter 6 connected downstream of the amplitude modulator 2 and is supplied to an, also downstream-connected, adder 7 of the phase-modulation converter 1 via its input 8. At a further input 9 that can be designated the carrier input, a further square-wave or sinusoidal adder carrier signal Sig_{AT} is fed to the adder 7, where the signal needs to be phase-displaced relative to the sinusoidal modulator carrier signal Sig_{MT}, in particular by 90°. It can also be said that the adder carrier signal Sig_{AT} is cosinusoidal. By way of the addition of the carrier-free amplitude signal Sig_{AM} and the sinusoidal adder carrier signal Sig_{AT}, a phase-modulated signal Sig_{PM} is obtained with interference-induced amplitude modulation.

Further, connected upstream of the adder 7 is a calibration switch S the configuration and use of which will be considered in greater detail below. In the exemplary embodiment shown here, the calibration switch S is arranged between the amplitude modulator 2 and the adder 7, specifically between the amplitude modulator 2 and the filter 6. It should be noted that the calibration switch S could be connected upstream of the amplitude modulator 2, i.e., it does not necessarily have to be arranged between the amplitude modulator 2 and the adder 7.

Arranged connected upstream of the calibration switch S is a galvanic separation G which, in this case, comprises a pair of coupling capacitors. This type of galvanic separation can be provided very easily in the case of a phase-modulation converter 1 and effectively at any desired site in the signal path P as far as the digital circuit element 15, which represents a significant advantage of the phase-modulation converter 1.

The signal Sig_{PM} is output at an output 10 of the adder 7 and is supplied to a limiter 11 via its input 12. The limiter 11 is configured to suppress an interference-induced amplitude modulation in the signal Sig_{PM}. The signal Sig_{BA} obtained which, in the present case, is also designated the limited signal, emerges at the output 13 of the limiter 11.

The signal Sig_{BA} now carries the modulation in temporally differing zero crossings as compared with the adder signal Sig_{AT} and/or the suppressed carrier signal Sig_{MT}. This is represented purely schematically in FIG. 1 above and to the right of the limiter 11. In each case, shown in a graph over time is the signal Sig_{BA} (top) and the signal Sig_{MT} (bottom) as well as the temporal offset Δt. The amplitude of the signal Sig_{BA} varies between 0 and 1, i.e., a signal that is digital in its amplitude is obtained.

The limited signal Sig_{BA} is supplied to an input 14 of a digital circuit element 15 that serves for demodulation of the signal Sig_{BA} and optionally further purposes. It should be noted that even if no further components are shown between the limiter 11 and the digital circuit element 15 in FIG. 1, it is certainly not precluded that any such are present. In other words, the limited signal Sig_{BA} can be supplied to the digital circuit element 15 directly or via further components, which can also necessitate a further processing of the signal.

The digital circuit element 15 can comprise at least one FPGA and/or ASIC or can be provided by at least one FPGA and/or ASIC. In the exemplary illustrated embodiment, the digital circuit element is provided by an FPGA 15.

A demodulation facility 16 of the apparatus 1 via which a digital demodulation of the limited signal Sig_{BA} can occur is implemented on the FPGA 15. The demodulation facility 16 can also be designated a digital demodulation.

In the context of the demodulation, inter alia, a sampling of the signal Sig_{BA} occurs via at least one sampling clock signal CLK0-CLK3, a comparison with the reference signal Sig_{RF} also sampled with the at least one sampling clock signal and an integration of the comparison. The generation of the reference signal Sig_{RF} and the comparison will be considered in further detail below.

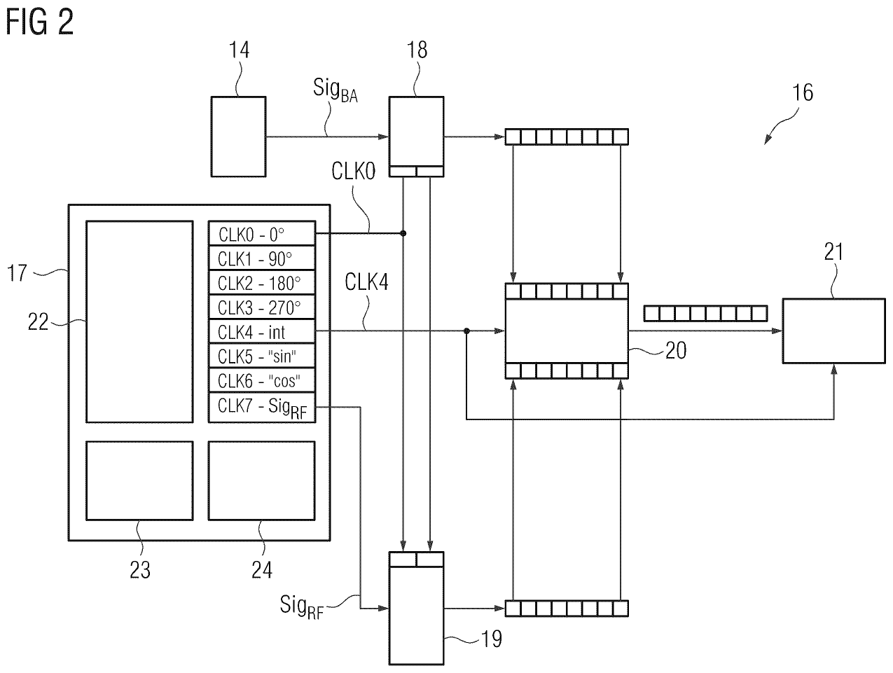

FIG. 2 contains a purely schematic block diagram relating to the digital demodulation making use of the demodulation facility 16, specifically in the event that a sampling occurs with a sampling clock signal CLK0.

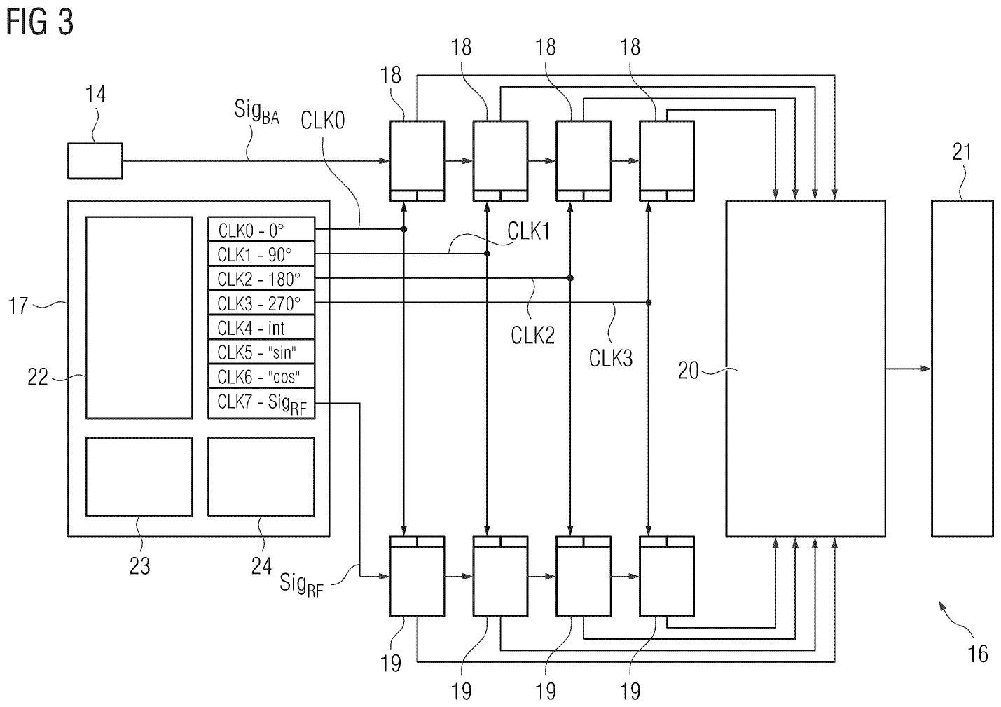

FIG. 3 shows an alternative exemplary embodiment for using a plurality of sampling clock signals for the sampling, which has proved to be particularly advantageous. FIG. 3 shows schematically, by way of example, the structure making use of four sampling clock signals CLK0, CLK1, CLK2, CLK3.

The demodulation facility 16 comprises a clock generator facility 17 and at least one buffer 18 for the limited signal Sig_{BA} that is preferably given by a FIFO buffer that is herein designated the signal buffer 18. Furthermore, at least one further buffer 19 is provided for the reference signal Sig_{RF} that is also preferably configured as a FIFO buffer and, in order to distinguish it from the buffer 18 for the signal Sig_{BA}, is designated the reference buffer 19. It should be noted that despite these different designations, the at least one signal buffer 18 and the at least one reference buffer 19 can be configured identically constructed and, in the present instance, are configured identically constructed.

The number of signal buffers 18 and the number of reference buffers 19 suitably agrees and corresponds to the number of sampling clock signals CLK0-CLK3 used. The demodulation facility 16 shown in FIG. 2 therefore comprises exactly one signal buffer 18 and exactly one reference buffer 19.

FIG. 3 shows, by way of example, that four sampling clock signals CLK0, CLk1, ClK2, CLK3 can be used for sampling the limited signal Sig_{BA} and simultaneously the reference signal Sig_{RF}. The demodulation facility 16 of FIG. 3 correspondingly comprises four, preferably identically constructed, signal buffers 18 and four, preferably identically constructed, reference buffers 19. In FIG. 1, for reasons of clarity, the buffers 18, 19 are shown behind one another and the frontmost buffer 18, 19 is drawn with a solid line while the buffers 18, 19 behind them are drawn with dashed lines to indicate that they can be present optionally.

Connected downstream of the buffers 18, 19 and connected to the outputs of the buffers 18, 19 is an XOR module 20 that can comprise an XOR gate or can be provided by such a gate. Specifically, it is the case that the output of the at least one signal buffer 18 is connected to an input of the XOR module 20 and the output of the at least one reference buffer 19 is connected to the other input of the XOR module 20, so that values that are output are transferred thereto and can be compared. In the exemplary embodiment of FIG. 3, the outputs of all four signal buffers 18 are connected to the one input of the XOR module 20 and the outputs of all four reference buffers 19 are connected to the other input of the XOR module 20.

Furthermore, provided connected downstream of the XOR module 20 is an integrator 21, via which values output by the XOR module 20 can be integrated.

In the exemplary embodiments shown in FIGS. 2 and 3, the clock generator facility 17 of the demodulation facility 16 comprises, in total, three clock blocks and/or clock modules 22, 23, 24. With these three clock blocks 22, 23, 24, in total seven signals CLK0, CLK1, CLK2, CLK3, CLK4, CLK5, CLK6, CLK7 are generated, including the sampling clock signals used for the sampling CLK0 (FIG. 2) and/or CLK0, ClK1, CLK2, CLK3 (FIG. 3).

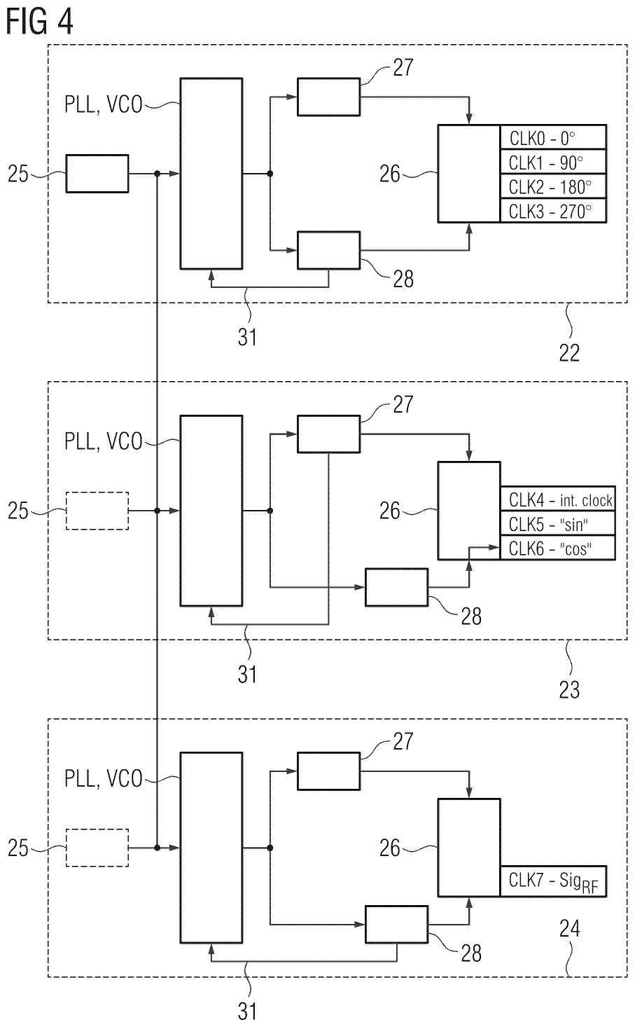

Each of the clock modules 22, 23, 24 therein comprises a phase-locked loop PLL with a voltage-controlled oscillator VCO. The internal structure of the three clock blocks 22, 23, 24 is shown (again greatly simplified and purely schematically) in FIG. 4. Herein, the phase-locked loop PLL with the voltage-controlled internal oscillator VCO of the respective clock block 22, 23, 24 is shown in simplified form as a block element.

The internal oscillator VCO of each clock module 22, 23, 24 is regulated out to an external reference signal by an external clock source 25 that can be provided, for example, by a quartz resonator, with a suitably adjusted factor to a higher internal frequency f_{VCO}. The three clock modules 22, 23, 24 can be supplied by the same external clock source 25, although this does not necessarily have to be the case.

The clock modules 22, 23, 24 can each be provided, for example, by a mixed-mode clock manager (MMCM) module and/or block or can comprise such a module and/or block. The manufacturers Xilinx and/or AMD offer, for example, FPGAs with such modules and/or blocks.

Each of the clock modules 22, 23, 24 has a plurality of clock outputs which, in FIG. 4 are indicated via a block element provided with the reference sign 26. Each clock output can assume different divisor values and, thus frequencies, and different fixedly defined phase positions. All the clock pulses are therein derived from f_{VCO}. Shown beside the block element 26 representing the clock outputs are the clock signals CLK0, CLK1, CLK2, CLK3, CLK4, CLK5, CLK6, CLK7 generated and output by the respective clock signal block 22, 23, 24 in the respective exemplary embodiment. The corresponding numbering CLK0, CLK1, CLK2, CLK3, CLK4, CLK5, CLK6, CLK7 is also shown in FIGS. 2 and 3, aside from arrows regarding their corresponding use, which will be further considered below. Each clock signal block 22, 23, 24 and/or its oscillator VCO has both phase-locked taps 27 and also at least one phase-variable tap 28. The phase-variable tap 28 enables a subdivision of the phase position into fine steps. In the exemplary embodiments described here, a subdivision into 56 steps can occur, i.e., into steps of 360°/n, where n=56. The number of 56 steps is to be understood as exemplary.

The clock module 22 is used to provide the rapid sampling pulses, i.e., sampling clock signals for the sampling of both the limited signal Sig_{BA} and also the reference signal Sig_{RF}. The example of FIG. 2 concerns the sampling clock signal CLK0, and that of FIG. 3 concerns the sampling clock signals CLK0-CLK3. This module is designated the sampling clock signal generating module 22.

Purely by way of example, for a frequency of the rapid sampling clock signals CLK0, CLK1, CLK2, CLK3, which is derived from f_{VCO}, 256 MHz is given. f_{VCO} can be, for example, 1024 MHz. It should be understood other frequencies are also possible. It is suitably the case that the frequency of the (respective) sampling clock signal CLK0-, CLK1, CLK2, CLK3 is at least one order of magnitude, preferably two orders of magnitude, higher than the modulator frequency of the amplitude modulator 2.

The second clock module 23 serves for generating slow internal signals. In the exemplary described embodiment, it generates the clock signals CLK4, CLK5 and CLK6. CLK4 is a relatively slow internal clock signal which, in the present instance is 32 MHz, which should again be understood as exemplary and which is used for the puffers 18, 19 and the XOR module 20 and the integrator 21, which is indicated in FIG. 2 with corresponding arrows. CLK5 corresponds to a square-wave or sinusoidal signal. CLK6 corresponds to a signal offset from the square-wave and/or sinusoidal signal, in particular a cosinusoidal signal. The square-wave and/or sinusoidal signal are output via an output 29 of the FPGAs 15 in the direction of the adder 7 to obtain Sig_{AT} and to supply it to the input 9 of the adder 7. Via an output 30 of the FPGA 15, the cosinusoidal signal is output as Sig_{MT} in the direction of the amplitude modulator 2, specifically the input 4 thereof. It should be noted that an analog filter 6 is also arranged between the output 29 of the FPGA 15 and the input 9 of the adder 7. However, no such filter is shown arranged between the output 30 of the FPGA 15 and the input 4 of the amplitude modulator 2, although it is also not precluded that one such is also provided here. The second module, because it serves for generating the modulator carrier signal Sig_{MT} and the adder carrier signal Sig_{AT}, is designated the carrier signal generating module 23.

The third clock module 24 serves to generate CLK7, which corresponds to the reference signal Sig_{RF} and/or is used for its generation. This is a purely internal signal that does not leave the FPGA 15. This module is designated the reference signal generating module 24.

The three modules 22, 23, 24 can substantially match one another in their construction. There can, however, be differences, as further discussed below.

During operation of the apparatus, in the case of FIG. 2, the one signal buffer 18 serves for sampling the limited signal Sig_{BA} with the rapid sampling clock signal CLK0 and/or, in the case of FIG. 3, the four signal buffers 18, for the sampling of the limited signal Sig_{BA} with the four fast sampling clock signals CLK0, CLK1, CLK2, CLK3 that are fixedly phase-offset to one another and the synchronization to the slower internal clock domains. On the input side, the limited signal Sig_{BA} is supplied to each (respective) signal buffer 18 for sampling. Each (respective) signal buffer 18 receives both one of the rapid sampling clock signals CLK0, CLK1, CLK2, CLK3 for sampling, this coming from the sampling clock signal generating module 22, as well as the slower internal clock signal CLK4 to which the synchronization takes place by means of the (respective) signal buffer 18, this coming from the carrier signal generating module 23. It should be noted that in FIG. 3, for the use of the plurality of sampling clock signals CLK0, CLK1, CLK2, CLK3 and associated buffers 18, 19, the arrows for the slower internal clock signal CLK4 are not drawn in for the sake of clarity.

Each signal buffer 18 has an input with a bit width of 1 and an output with a bit width of 8. The ratio of the bit widths of the input to the output of each signal buffer 18 is selected similarly to the ratio of the clock signals CLKi/CLK4 where i=0, 1, 2, 3, or vice versa. In the example shown here, CLKi/CLK4=256 MHz/32 MHz=8, where i=0, 1, 2, 3.

Whenever 8 sampling values have “accumulated” in a signal buffer 18, this plurality of values is output by the signal buffer 18, specifically to the XOR module 20. The output occurs with a slower clock signal from CLK4, i.e., in the present instance, 32 MHz. It can also be stated that each signal buffer 18 provides as the output the “sampled” digitally limited signal Sig_{BA} in the correct chronological sequence.

For each reference buffer 19, the above applies entirely accordingly with the difference that the limited signal Sig_{BA} is not supplied to it, but rather that the reference signal Sig_{RF} for sampling with the (respective) rapid sampling clock signal CLK0, CLK1, CLK2, CLK3 and for synchronization to CLK4 is supplied to it, as indicated schematically in FIGS. 2 and 3 by associated arrows.

Thus, the “sampled” digital reference signal is obtained from each reference buffer 19, where the signal is synchronized with the same clock signal CLK0 and/or with the same clock signals CLK0, CLK1, CLK2, CLK3. Thus, the temporal sequence fits the “sampled” limited Sig_{B}A signal which is obtained from the signal buffer(s) 18.

In the embodiment of FIG. 3 with the four sampling clock signals CLK0, CLK1, CLK2, CLK3, each signal buffer 18 outputs a different part of the signal. Each CLK sampling domain supplies a data block. In the same domain, appropriately thereto, the reference signal Sig_{RF} is “sampled”. In the XOR module 20, a comparison can then be carried out “block-by-block”.

In order to achieve an enhanced resolution, in the context of the sampling, it can be provided in an advantageous embodiment the phase position of the one sampling clock signal CLK0 (FIG. 2) and/or of the plurality of sampling clock signals CLK0, CLK1, CLK2, CLK3 (FIG. 3) that are used for the sampling of the limited signal Sig_{BA} and of the reference signal Sig_{RF} is changed dynamically. For this purpose, the feedback path 31 of the sampling clock signal generating module 22 is connected to the phase-variable tap 28 of the oscillator VCO.

The phase position of the signal supplied back to the oscillator VCO via the feedback path 31 is continuously and/or repeatedly changed. This preferably occurs cyclically, for example, every few microseconds, for instance, every 42 microseconds. The displacement of the phase position therein occurs by steps of 360°/56 and in the same direction. A resolution-increasing logic system 32 is provided (see FIG. 1) that is preferably implemented on the FPGA 15, which also comprises or forms the demodulation facility 16 and that implements the corresponding control for the dynamic phase position change of the sampling clock signals. The resolution-increasing logic system 32 can form a constituent part of the demodulation facility 16.

In the exemplary embodiment of FIG. 3, the plurality of sampling clock signals CLK0, CLK1, CLK2, CLK3 are all generated from the output signal of the one oscillator VCO of the sampling clock signal generating module 22. Consequently, the repeated change of the phase position of the feedback signal results in a repeated change of the phase positions of all the sampling clock signals CLK0, CLK1, CLK2, CLK3 used for the sampling, synchronously and by equal-sized steps.

With the stepping of the feedback signal via the feedback path 31, the phase position of all the CLK outputs of the sampling clock signal generating module 22 also changes synchronously with each phase step of the oscillator VCO. The individual sampling clock signals CLK0, CLK1, CLK2, CLK3 can additionally be offset to one another by 90° in an unchanging manner.

In the case described, a phase step of

$${t}_{STEP} = 1 / ( 768 {MHz}^{*} 56 ) = 1 / 43.008 GHz = 23.25 ps .$$

With the 256 MHz sampling clock signals CLK0-CLK3 offset by 90° to one another, a phase difference of only

$${t}_{diff} = 1 / ( 256 {MHz}^{*} 4 ) = 976.56 ps$$

must be bridged in order to cover all the possible discrete sampling points via the fine-stepped phase steppings. In the FPGA 15, 42 (976.56 ps/23.25 ps) periods of the modulator frequency are summed.

The computational resolution is given by:

$$log 2 ( 90 ° / 360 {{°}^{}}^{*} 43008 MHz / 1 MHz ) = 13.39 bits$$

without changing the frequency of the amplitude modulator 2.

The data rate falls from 1 MHz to 1 MHz/42=23.8 kHz.

Without the dynamic phase displacement, however, a computational resolution of

$$log 2 ( 90 ° / 360 {°}^{*} {4}^{*} 256 MHz / 1 MHz ) = 8 bits would result .$$

With the XOR module 20 connected downstream of the buffers 18, 19, following the rapid sampling and the synchronization, time points at which the limited signal Sig_{BA} and the reference signal Sig_{RF} are different is established. The subsequent integration via the integrator 21 produces the changed value, which is output as Sig_{O} by the FPGA 15 (see FIG. 1).

Suitably, integration occurs until the above described dynamic change of the phase position of the sampling clock signals CLK0, CLK1, CLK2, CLK3 over an angular range of 360°/m has occurred, where m represents the number of sampling clock signals used by the limited signal Sig_{BA} for the sampling. The apparatus 1 in accordance with disclosed embodiments of the invention, in particular, its demodulation facility 16 and/or an FPGA 15 of the apparatus can be configured accordingly.

In the phase-modulation converter 1, there can be, for example, PCB time delay differences, which can lead to false and/or inexact outputs. For this reason, the calibration of the phase-modulation converter 1 as described below is performed at least once, in particular, before its first operation by a user, for instance, ex works and/or at least once more after being put into operation.

The calibration can also be performed, in particular, if a measurement of bidirectional input voltages using the phase-modulation converter 1 is desired.

Depending upon whether unipolar or bidirectional signals are to be measured, the phase zero position should suitably be different (180° as against 90°). This is indicated purely schematically in FIG. 5. Therein, the reference signal Sig_{RF} is shown at top and thereunder the limited signal Sig_{BA} twice, specifically, centrally in an optimum starting position for a unidirectional measurement and at bottom, in an optimum starting position for a bidirectional measurement.

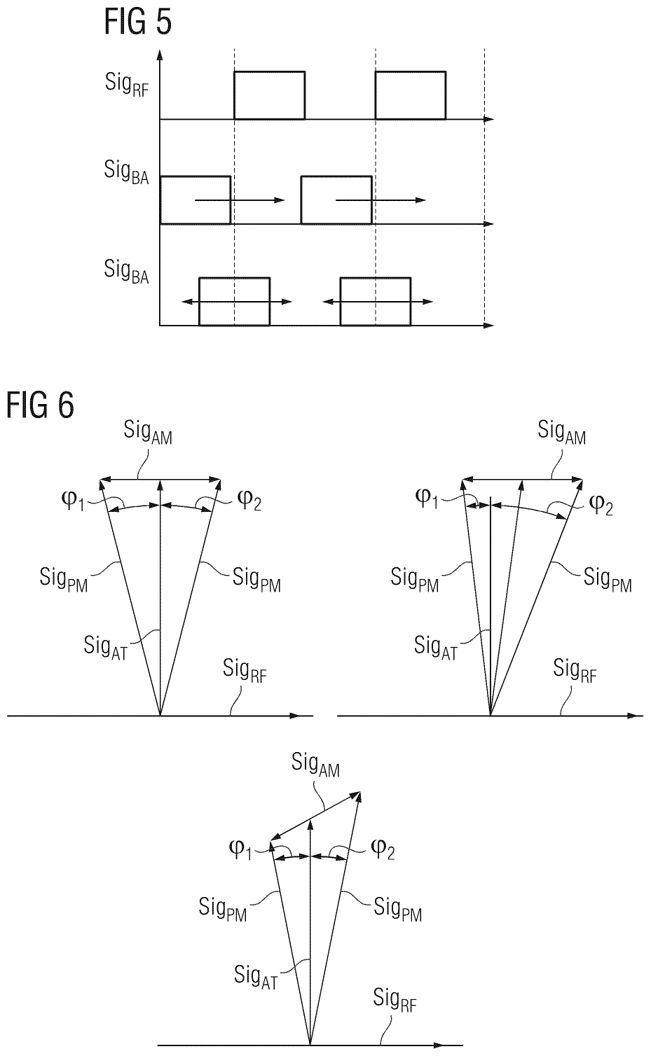

Furthermore, it is ideally the case that, in particular, despite possible time delay differences on the circuit board, a phase offset of 90° is maintained as precisely as possible between the modulator carrier signal Sig_{MT} and the adder carrier signal Sig_{AT} that is offset therefrom. A deviation from the 90° results in a different-sized phase shift into the different directions. This can be illustrated in its simplest form with vector diagrams as shown in FIG. 6.

Therein, the upper vector diagram shows the ideal case in which the phase offset between the added carrier for phase modulation, i.e., the adder carrier signal Sig_{AT} and the carrier-suppressed amplitude modulation Sig_{AM} and/or the signal Sig_{MT}, is exactly 90°. From this, there results an even phase shift of the phase modulation Sig_{PM} to the reference signal Sig_{RF}.

The middle vector diagram shows the case that, for instance, due to time delay errors on the circuit board, the adder carrier Sig_{AT} does not lie exactly at 90° to the carrier-suppressed amplitude modulation Sig_{AM} and/or the signal Sig_{MT}. The phase shift of the phase modulation Sig_{PM} to the reference signal Sig_{RF} resulting therefrom is no longer even.

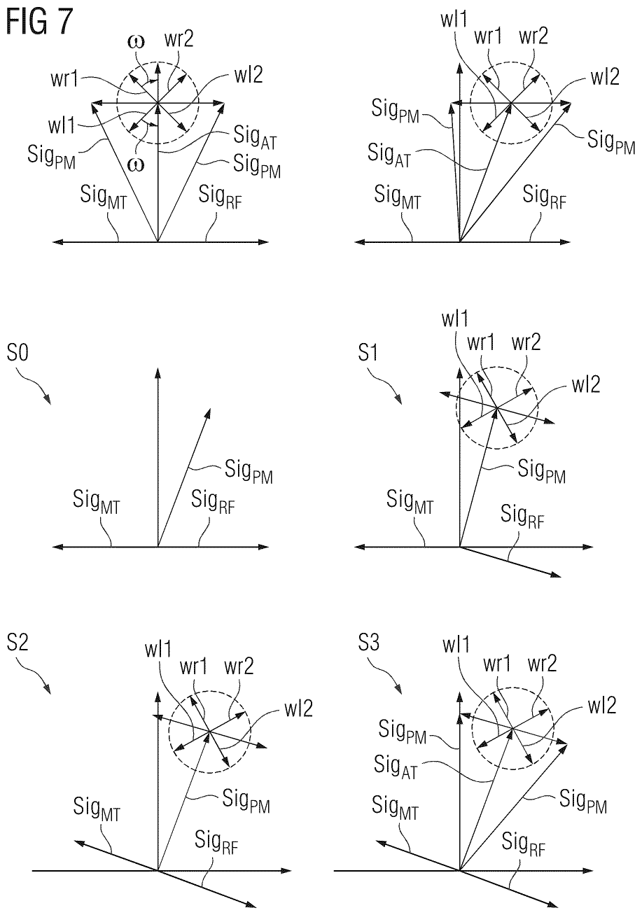

The lower vector diagram shows the case of a deviation of 90° despite the adaptation of the reference signal Sig_{RF}. Even if the reference signal Sig_{RF} is adapted to the adder carrier signal Sig_{AT}, the resulting phase shift due to the displaced carrier-suppressed amplitude modulation Sig_{AM} and/or the signal Sig_{MT} is no longer necessarily a maximum. Therefrom, a smaller resolution of the phase-modulation converter can result. This can also be prevented via the following calibration. For the calibration, the calibration switch S is initially brought into the calibration setting, provided it is not already in this position. In FIG. 7, this first step occurs if needed, is marked as S0. In the calibration setting, the input 6 of the adder 7, and/or in the event of a differential signal transfer, the two inputs 6 of the adder 7 are no longer connected to the output 5 (and/or the outputs) of the amplitude modulator 2, but rather to earth or ground. It can also be stated that the amplitude modulation Sig_{AM} becomes zero and the phase modulation Sig_{PM} becomes Sig_{AM}, in the present case the cosine, which arrives (regardless of the setting of the calibration switch S) again at the input 9 of the adder 7.

In order to set the input voltage to 0V, in particular, solid state relays (SSRs) or simple MEMS switches are suitable because with these the advantage of the phase-modulation converter 1 of a possible purely passive circuit on the process side can again be used. The calibration switch S can accordingly comprise a solid state relay and/or at least one MEMS switch, or can be provided thereby. This can be, in particular, a changeover switch.

Subsequently, in a step S1 in the calibration setting of the calibration switch S, the phase position of the reference signal Sig_{RF} is changed dynamically and a phase position of the reference signal Sig_{RF} is found at which the output signal of the demodulation facility 16, specifically the digital value Sig_{O}, assumes a calibrated value that represents the maximum value achievable at this phase displacement of the reference signal Sig_{RF} or differs by not more than a pre-determined maximum deviation from the maximum value achievable at this phase displacement. It can also be stated that initially a displacement of the reference signal Sig_{RF} starts so that the digital value Sig_{O} becomes as large as possible and/or is maximized.

In order to realize the dynamic phase displacement of the reference signal Sig_{RF}, the feedback path 31 of the oscillator VCO of the reference generating module 24, as shown in FIG. 4 at the bottom, can be connected to the phase-variable tap 28. In an alternative thereto, the phase-variable tap 28 can also be used directly for generating the reference signal Sig_{RF}, i.e., this signal can be provided therefrom and/or tapped off here. It can also be stated that, in this instance, the phase-variable tap 28 is not used for the feedback path, but for the “forward path”. The feedback path 31 is then suitably connected to the phase-locked tap 27 of the reference generating module 24. A corresponding embodiment is not shown in FIG. 4 for the module 24, but for the module 23, which is described in greater detail below.

Also provided is a reference logic system 33, which implements the displacement to find the maximum (possible) value. The reference logic 33 is implemented on the FPGA 15 of the demodulation facility 16, which is also to be understood as exemplary. The displacement can occur multiple times and/or repeatedly, by steps of 360°/56, as previously described in relation to the module 22.

In the next step S2, the reference signal is not displaced further, but rather (while retaining the phase position of the reference signal Sig_{RF} found in step S1) is now actively displaced Sig_{MT} to Sig_{AT}, thus in the present instance, from sin to cos. This is performed until a phase position of the modulator carrier signal Sig_{M} and/or the adder carrier signal Sig_{AT} is found at which the output signal Sig_{O} of the demodulation facility assumes a calibrated value that represents the maximum value achievable at this phase displacement or differs by not more than a pre-determined maximum deviation from the maximum value achievable at this phase displacement.

In the present example, the phase position of the adder carrier signal Sig_{AT}, i.e., the cos, is displaced and/or changed. It should be understood that alternatively, the modulator carrier signal Sig_{MT} could naturally be changed in its phase position.

The maximum Sig_{O} while changing the phase relationship between Sig_{MT} and Sig_{AT} results when these signals are offset by 90° to one another. In order to realize the dynamic phase displacement of the adder carrier signal Sig_{AT}, for this signal also, a phase-variable output 28 is used, specifically that of the oscillator VCO of the carrier generator module 23. It can also be said that the adder carrier signal Sig_{AT} is output via and/or by the phase-variable output 28 and/or can be tapped off therefrom. The phase-variable tap 28 can thus be said to be used for the “forward path”. For the sake of completeness, it should be noted that alternatively, it is, in principle also possible that the phase-variable tap 28 is connected to the feedback path 31. This is the case if, for the generation of the modulator carrier signal Sig_{M} and the adder carrier signal Sig_{AT}, separate modules are provided (not shown in the figures).

Also provided for the displacement of the adder carrier signal Sig_{AT} is an adder logic system 34, which implements the displacement using the phase-variable tap 28 to find the maximum (possible) value. The adder logic 34 is implemented on the FPGA 15 of the demodulation facility 16, which is also to be understood as exemplary. Here also, the displacement and/or change of the phase position can occur, in principle, as described above for the modules 22 and 24.

Subsequently, a changeover takes place into the control setting of the calibration switch S, an input voltage of 0V is applied to the phase-modulation converter 1 and, in step S3, the phase position of the reference signal Sig_{RF} is changed again, preferably dynamically, and therein a phase position of the reference signal Sig_{RF} is found at which an output signal Sig_{O} of the demodulation facility 16 assumes a calibrated value which is either zero or differs by not more than a pre-determined maximum deviation from zero or which represents half of the maximum value achievable at this phase displacement or which differs by not more than a pre-determined maximum deviation from half of the maximum value achievable at this phase displacement. This occurs depending on whether a unidirectional (zero) or bidirectional (max/2) measurement of, in particular, an input voltage is to be realized. For this purpose, it is also possible to make use of the reference logic 33.

Optionally, in step S4, a “direction test” and possibly an adaptation can also be performed. It can thus be provided that in step S4, if the calibration switch S is in the control setting, then an input voltage other than zero is applied to the phase-modulation converter 1 and a check is performed to determine whether the output signal of the demodulation facility 16 in the event of an input voltage of over zero assumes a value that is greater than the value of the output signal at 0V input voltage and, in the event of an input voltage of below zero, assumes a value that is smaller than the value at an input voltage of 0V. If this is not the case, then the phase position of the reference signal Sig_{RF} is suitably displaced by 180°. It can also be changed, preferably dynamically, in one direction until the value of the output signal of the demodulation facility 16 at which it started comes about again. This change of the phase position of the reference signal Sig_{RF} is suitably performed if an input voltage of 0V is applied to the phase-modulation converter 1.

In FIG. 7, the above-described steps and/or their result are visualized, as previously mentioned, with the aid of vector diagrams. With step S3, a symmetrical phase shift is achieved. In the vector diagram situated at the top left in FIG. 7, specifically above that for step S0, the ideal case is shown again and beside it to the right, i.e., above the vector diagram for step S1, the case of a non-90° offset from Sig_{MT} to Sig_{AT} is shown. Herein, wl1, wl2, wr1, wr2 are the left-rotating and/or right-rotating pointers at the two different time points t1 and t2. Also shown are the pointers resulting from the parallelogram wr, wl.

With the dynamic calibration of the offset and the correction of the distortion of the necessary, rigid 90° phase offset between Sig_{MT} and Sig_{AT}, in the present instance sin and cos, at runtime, it is possible to compensate for production and construction tolerances. Furthermore, in this way, the possibility arises for realizing bidirectional industrial analog input channels with little circuit complexity. As soon as there are requirements for a potential separation of the analog channels from the evaluating logic system, the solution can also be realized via a phase-modulation converter 1 in accordance with the invention that can be calibrated during operation significantly more easily than was previously achieved.

Furthermore, the property of the phase-modulation converter 1 that the input voltage Sig_{A} mapped via an arctan function onto an output voltage Sig_{O} can thereby be still better utilized. Small changes in the phase difference about the zero position result in a greater signal swing as compared with the same change at the edge of the input voltage region. This means that the signal-to-noise ratio is greatest about the zero position.

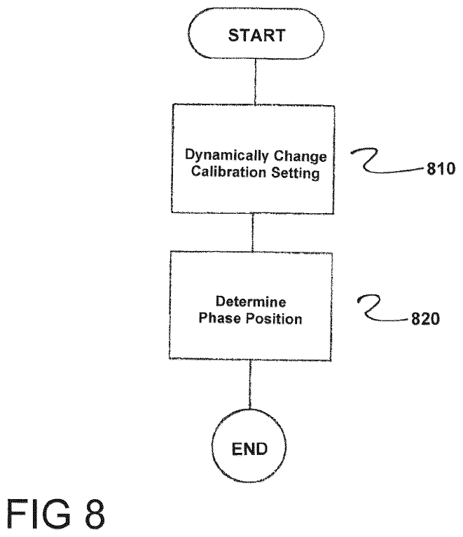

FIG. 8 is a flowchart of the method for calibrating a phase-modulation converter P. The phase-modulation converter 1 includes an amplitude modulator 2 with carrier suppression to which an input signal Sig_{A} to be converted is suppliable on an input side to obtain a carrier-free amplitude-modulated signal Sig_{AM}, an adder 7 to add a phase-displaced, sinusoidal adder carrier signal Sig_{AT} to the carrier-free amplitude-modulated signal Sig_{AM} and to obtain a phase-modulated signal Sig_{PM}, a limiter 11 to which the phase-modulated signal Sig_{PM} is suppliable and with which an interference-induced amplitude modulation in the phase-modulated signal Sig_{PM} is suppressible, and a demodulation facility 16 to which the signal Sig_{BA} output by the limiter 11 is suppliable and demodulated therein, where a comparison of the signal Sig_{BA} output by the limiter with a reference signal Sig_{RF} occurs in a context of the demodulation, and the adder carrier signal Sig_{AT} is generated in the demodulation facility 16.

The phase-modulation converter 1 further includes a calibration switch S which is connected upstream of the adder 7, between the amplitude modulator 2 and the adder 7, and which is actuatable between a control setting in which the adder 7 is connected via the calibration switch S to the input of the phase-modulation converter 1, and at least one calibration setting in which the connection between the adder 7 and the input of the phase-modulation converter 1 is interrupted and another connection comprising a connection of the adder 7 to earth or ground is created.

The method comprises changing in a calibration setting of the calibration switch S, when a connection to earth or ground is made, the phase position of the reference signal dynamically, as indicated in step 810.

Next, a phase position of the reference signal at which an output signal of the demodulation facility assumes a calibrated value which represents a maximum value achievable at this phase displacement or differs by not more than a pre-determined maximum deviation from the maximum value achievable at this phase displacement is determined, as indicated in step 820.

Although the invention has been illustrated and described in detail with the preferred exemplary embodiment, the invention is not restricted by the examples disclosed and other variations can be derived therefrom by a person skilled in the art without departing from the protective scope of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for calibrating a phase-modulation converter, the phase-modulation converter including an amplitude modulator with carrier suppression to which an input signal to be converted is suppliable on an input side to obtain a carrier-free amplitude-modulated signal, an adder to add a phase-displaced, sinusoidal adder carrier signal to the carrier-free amplitude-modulated signal and to obtain a phase-modulated signal, a limiter to which the phase-modulated signal is suppliable and with which an interference-induced amplitude modulation in the phase-modulated signal is suppressible, and a demodulation facility to which the signal output by the limiter is suppliable and demodulated therein, a comparison of the signal output by the limiter with a reference signal occurring in a context of the demodulation, and the adder carrier signal being generated in the demodulation facility, the phase-modulation converter further including a calibration switch which is connected upstream of the adder, between the amplitude modulator and the adder, and which is actuatable between a control setting in which the adder is connected via the calibration switch to the input of the phase-modulation converter, and at least one calibration setting in which the connection between the adder and the input of the phase-modulation converter is interrupted and another connection comprising a connection of the adder to earth or ground is created, the method comprising:
changing in a calibration setting of the calibration switch, when a connection to earth or ground is made, the phase position of the reference signal dynamically; and
determining a phase position of the reference signal at which an output signal of the demodulation facility assumes a calibrated value which represents a maximum value achievable at this phase displacement or differs by not more than a pre-determined maximum deviation from the maximum value achievable at this phase displacement.

2. The method as claimed in claim 1, wherein the reference signal is generated from the output signal of a voltage-controlled oscillator which forms a constituent part of a phase-locked loop and the dynamic change in the phase position of the reference signal is achieved;
wherein the phase position of a feedback signal for the oscillator, which is tapped off on the output side of the oscillator and is supplied to the oscillator again, on the input side, is dynamically changed by steps of less than 40°;
wherein the oscillator includes at least one phase-variable tap and at least one phase-locked tap;
wherein the at least one phase-variable tap enables a 360° phase position of the oscillator to be subdivided into n steps, n being a natural number greater than or equal to 30; and
wherein one of (i) the reference signal is obtained from the phase-variable tap and (ii) the phase-variable tap is connected to the feedback path of the oscillator such hat a signal originating from the phase-variable tap can be supplied back again as a feedback signal to the oscillator on the input side, and the phase position of the signal originating from the phase-variable tap is changed dynamically by steps of 360°/n.

3. The method as claimed in claim 1, wherein a carrier signal comprising the modulator carrier signal generated via the demodulation facility is supplied to the amplitude modulator for the carrier suppression at a second input of the amplitude modulator, the method further comprising:
changing dynamically, in the calibration setting of the calibration switch when a connection to earth or ground is made, the phase position of at least one of (i) the modulator carrier signal and (ii) the adder carrier signal; and
finding therein a phase position of at least one of (i) the modulator carrier signal and (ii) the adder carrier signal at which an output signal of the demodulation facility assumes a calibrated value which represents the maximum value achievable at this phase displacement or differs by not more than a pre-determined maximum deviation from the maximum value achievable at this phase displacement.

4. The method as claimed in claim 2, wherein a carrier signal comprising the modulator carrier signal generated via the demodulation facility is supplied to the amplitude modulator for the carrier suppression at a second input of the amplitude modulator, the method further comprising:
changing dynamically, in the calibration setting of the calibration switch when a connection to earth or ground is made, the phase position of at least one of (i) the modulator carrier signal and (ii) the adder carrier signal; and
finding therein a phase position of at least one of (i) the modulator carrier signal and (ii) the adder carrier signal at which an output signal of the demodulation facility assumes a calibrated value which represents the maximum value achievable at this phase displacement or differs by not more than a pre-determined maximum deviation from the maximum value achievable at this phase displacement.

5. The method as claimed in claim 3, wherein at least one of the modulator carrier signal and the adder carrier signal is generated from the output signal of a voltage-controlled oscillator which forms part of a phase-locked loop and the dynamic change in the phase position of at least one of the modulator carrier signal and the adder carrier signal is achieved;
wherein the phase position of a feedback signal for the oscillator, which is tapped off on the output side of the oscillator and is supplied to the oscillator again on the input side, is dynamically changed by steps of less than 40°;
wherein the oscillator includes at least one phase-variable tap and at least one phase-locked tap;
wherein the at least one phase-variable tap enables the 360° phase position of the oscillator to be subdivided into n steps, n being a natural number greater than or equal to 30; and
wherein one of the modulator carrier signal and the adder carrier signal is obtained from the phase-variable tap or the phase-variable tap is connected to the feedback path of the oscillator such that a signal originating from the phase-variable tap can be supplied back again as a feedback signal to the oscillator on the input side, and the phase position of the signal originating from the phase-variable tap is changed dynamically by steps of 360°/n.

6. The method as claimed in claim 3, further comprising:
changing, in the control setting of the calibration switch the phase position of the reference signal dynamically again; and
finding therein a phase position of the reference signal at which an output signal of the demodulation facility assumes a calibrated value which is either zero, which differs by not more than a pre-determined maximum deviation from zero, which represents half of the maximum value achievable at this phase displacement or which differs by not more than a pre-determined maximum deviation from half of the maximum value achievable at this phase displacement.

7. The method as claimed in claim 5, further comprising:
changing, in the control setting of the calibration switch the phase position of the reference signal dynamically again; and
finding therein a phase position of the reference signal at which an output signal of the demodulation facility assumes a calibrated value which is either zero, which differs by not more than a pre-determined maximum deviation from zero, which represents half of the maximum value achievable at this phase displacement or which differs by not more than a pre-determined maximum deviation from half of the maximum value achievable at this phase displacement.

8. The method as claimed in claim 6, further comprising:
applying an input voltage other than zero to the phase-modulation converter if the calibration switch is in the control setting; and
checking whether the output signal of the demodulation facility, in an event of an input voltage of over zero assumes a value which is greater than the value of the output signal at 0V input voltage and, in an event of an input voltage of below zero, assumes a value which is smaller than the value at an input voltage of 0V;
wherein in cases that this is not so, the phase position of the reference signal is dynamically changed in one direction until at least one of a phase position change of 180° is achieved and the value of the output signal of the demodulation facility at which it started comes about again, if an input voltage of 0V is applied to the phase-modulation converter.

9. The method as claimed in claim 1, wherein the phase-modulation converter comprises at least one galvanic separation; and wherein the at least one galvanic separation is at least one of connected upstream of the calibration switch and comprises at least one pair of coupling capacitors.

10. A phase-modulation converter comprising:
an amplitude modulator with carrier suppression to which an input signal to be converted is suppliable on the input side in order to obtain a carrier-free amplitude-modulated signal;
an adder to add a phase-displaced sinusoidal, adder carrier signal to the carrier-free amplitude-modulated signal and to obtain a phase-modulated signal;
a limiter to which the phase-modulated signal is suppliable and with which an interference-induced amplitude modulation in the phase-modulated signal is suppressible;
a demodulation facility to which the signal output by the limiter is suppliable and demodulated therein, a comparison of the signal output by the limiter with a reference signal occurring in a context of the demodulation, and the adder carrier signal being generatable in the demodulation facility; and
a calibration switch which is connected upstream of the adder, between the amplitude modulator and the adder, and which is actuatable between a control setting in which the adder is connected via the calibration switch to the input of the phase-modulation converter, and at least one calibration setting in which the connection between the adder and the input of the phase-modulation converter is interrupted and another connection comprising connection of the adder to earth or ground is created;
wherein the phase-modulation converter is at least one of constructed and configured in order, for a calibration, to dynamically change the phase position of the reference signal, and to find a phase position of the reference signal at which an output signal of the demodulation facility assumes a calibrated value which represents a maximum value achievable at this phase displacement or differs by not more than a pre-determined maximum deviation from the maximum value achievable at this phase displacement.

11. The phase-modulation converter as claimed in claim 10, further comprising:
a logic system comprising a reference logic system which is configured to dynamically change the phase position of the reference signal, and to find therein the phase position of the reference signal at which the output signal of the demodulation facility assumes the calibrated value which represents the maximum value achievable at this phase displacement or differs by not more than the pre-determined maximum deviation from the maximum value achievable at this phase displacement.

12. The phase-modulation converter as claimed in claim 10, wherein the demodulation facility of the phase-modulation converter includes a reference signal generating module for generating the reference signal;
wherein the reference signal generating module comprises a voltage-controlled oscillator which forms part of a phase-locked loop;
wherein the reference signal is generatable from the output signal of the oscillator;
wherein the oscillator includes at least one phase-variable tap and at least one phase-locked tap;
wherein the at least one phase-variable tap enables a 360° phase position of the oscillator to be subdivided into n steps, n being a natural number greater than or equal to 30; and
wherein one of (i) the reference signal is obtainable from the phase-variable tap and (ii) the phase-variable tap is connected to the feedback path of the oscillator so that a signal originating from the phase-variable tap can be fed back again as a feedback signal to the oscillator on the input side, and the phase-modulation converter is configured to dynamically change the phase position of the signal originating from the phase-variable tap of the oscillator of the reference signal generating module by steps of 360°/n.

13. The phase-modulation converter as claimed in claim 11, wherein the demodulation facility of the phase-modulation converter includes a reference signal generating module for generating the reference signal;
wherein the reference signal generating module comprises a voltage-controlled oscillator which forms part of a phase-locked loop;
wherein the reference signal is generatable from the output signal of the oscillator;
wherein the oscillator includes at least one phase-variable tap and at least one phase-locked tap;
wherein the at least one phase-variable tap enables a 360° phase position of the oscillator to be subdivided into n steps, n being a natural number greater than or equal to 30; and
wherein one of (i) the reference signal is obtainable from the phase-variable tap and (ii) the phase-variable tap is connected to the feedback path of the oscillator so that a signal originating from the phase-variable tap can be fed back again as a feedback signal to the oscillator on the input side, and the phase-modulation converter is configured to dynamically change the phase position of the signal originating from the phase-variable tap of the oscillator of the reference signal generating module by steps of 360°/n.

14. The phase-modulation converter as claimed in claim 10, wherein the amplitude modulator is connected to the demodulation facility and a carrier signal comprising the modulator carrier signal generated via the demodulation facility is suppliable to the amplitude modulator for the carrier suppression at a second input of the amplitude modulator;
wherein the phase-modulation converter includes a logic system comprising the adder logic system which is configured to dynamically change at least one of (i) the phase position of the modulator carrier signal and (ii) the phase position of the adder carrier signal, and configured to find a phase position of at least one of (i) the modulator carrier signal and (ii) the adder carrier signal at which an output signal of the demodulation facility assumes a calibrated value which represents a maximum value achievable at this phase displacement or which differs by not more than a pre-determined maximum deviation from the maximum value achievable at this phase displacement;
wherein the demodulation facility of the phase-modulation converter includes a carrier signal generating module for generating at least one of the modulator carrier signal and the adder carrier signal;
wherein the carrier signal generating module comprises a voltage-controlled oscillator which is forms part of a phase-locked loop, at least one of the modulator carrier signal and the adder carrier signal being generatable from an output signal of the oscillator;
wherein the oscillator includes at least one phase-variable tap and at least one phase-locked tap, the at least one phase-variable tap enables the 360° phase position of the oscillator to be subdivided into n steps, n being a natural number greater than or equal to 30; and
wherein one of the modulator carrier signal and the adder signal is one of (i) obtainable from the phase-variable tap and (ii) the phase-variable tap is connected to the feedback path of the oscillator such that a signal originating from the phase-variable tap can be supplied back again as a feedback signal to the oscillator on the input side, and the phase-modulation converter is configured to dynamically change the phase position of the signal originating from the phase-variable tap of the oscillator of the carrier signal generating module by steps of 360°/n.

15. The phase-modulation converter as claimed in claim 10, wherein the calibration switch is at least one of configured as a changeover switch, (ii) comprises at least one of at least one mechanical relay, at least one solid-state relay, at least one reed relay and at least one Micro-Electro-Mechanical Systems (MEMS) switch, or is provided thereby.

16. The phase-modulation converter (1) as claimed in claim 10, wherein the phase-modulation converter comprises at least one galvanic separation, the at least one galvanic separation being at least one of (i) connected upstream of the calibration switch and (ii) comprising at least one pair of coupling capacitors.

17. The phase-modulation converter as claimed in claim 10, wherein the phase-modulation converter is configured to:
change in a calibration setting of the calibration switch, when a connection to earth or ground is made, the phase position of the reference signal dynamically,
change dynamically, in the calibration setting of the calibration switch when a connection to earth or ground is made, the phase position of at least one of (i) the modulator carrier signal and (ii) the adder carrier signal,
find therein a phase position of at least one of (i) the modulator carrier signal and (ii) the adder carrier signal at which an output signal of the demodulation facility assumes a calibrated value which represents the maximum value achievable at this phase displacement or differs by not more than a pre-determined maximum deviation from the maximum value achievable at this phase displacement,
change, in the control setting of the calibration switch the phase position of the reference signal dynamically again, and
find therein a phase position of the reference signal at which an output signal of the demodulation facility assumes a calibrated value which is either zero, which differs by not more than a pre-determined maximum deviation from zero, which represents half of the maximum value achievable at this phase displacement or which differs by not more than a pre-determined maximum deviation from half of the maximum value achievable at this phase displacement.

18. The phase-modulation converter as claimed in claim 10, wherein the phase-modulation converter is configured to:
change in a calibration setting of the calibration switch, when a connection to earth or ground is made, the phase position of the reference signal dynamically,
change dynamically, in the calibration setting of the calibration switch when a connection to earth or ground is made, the phase position of at least one of (i) the modulator carrier signal and (ii) the adder carrier signal,
find therein a phase position of at least one of (i) the modulator carrier signal and (ii) the adder carrier signal at which an output signal of the demodulation facility assumes a calibrated value which represents the maximum value achievable at this phase displacement or differs by not more than a pre-determined maximum deviation from the maximum value achievable at this phase displacement,
change, in the control setting of the calibration switch the phase position of the reference signal dynamically again,
find therein a phase position of the reference signal at which an output signal of the demodulation facility assumes a calibrated value which is either zero, which differs by not more than a pre-determined maximum deviation from zero, which represents half of the maximum value achievable at this phase displacement or which differs by not more than a pre-determined maximum deviation from half of the maximum value achievable at this phase displacement,
apply an input voltage other than zero to the phase-modulation converter if the calibration switch is in the control setting, and
check whether the output signal of the demodulation facility, in an event of an input voltage of over zero assumes a value which is greater than the value of the output signal at 0V input voltage and, in an event of an input voltage of below zero, assumes a value which is smaller than the value at an input voltage of 0V, in cases this not being so, the phase position of the reference signal being dynamically changed in one direction until at least one of a phase position change of 180° is achieved and the value of the output signal of the demodulation facility at which it started comes about again, if an input voltage of 0V is applied to the phase-modulation converter.
